(19) United States
(12) Patent Application Publication
(10) Pub. No.: US 2014/0149890 A1
(43) Pub. Date: May 29, 2014

(54) METHOD AND DEVICE FOR DISPLAYING DATA

(71) Applicant: Tencent Technology (Shenzhen) Company Ltd., Shenzhen (CN)

(72) Inventors: Junxiu Zhu, Shenzhen (CN); Xue Zhang, Shenzhen (CN); Xiaofeng Wang, Shenzhen (CN); Puguang Huang, Shenzhen (CN)

(73) Assignee: Tencent Technology (Shenzhen) Company Ltd., Shenzhen (CN)

(21) Appl. No.: 14/169,307

(22) Filed: Jan. 31, 2014

Related U.S. Application Data
(63) Continuation of application No. PCT/CN2012/078852, filed on Jul. 19, 2012.

(30) Foreign Application Priority Data
Aug. 12, 2011 (CN) 201110230949.7

(51) Int. Cl. H04L 29/06; G06F 3/0481

(52) U.S. Cl. CPC H04L 65/403; G06F 3/0481
USPC 715/753

(57) ABSTRACT

Examples of the present disclosure provide a method and device for displaying data. The method includes the follows. Buddy data of user A is pulled. User data of a user, who uses an Application Program (APP) selected by user A, is pulled. User data of a user, who uses the APP and is a buddy of user A, is selected, based on the pulled buddy data and the pulled user data. The selected user data is displayed.

The application claims priority to a Chinese patent application 201110230949.7, titled “method and device for applying SNS platform”, which was filed on Aug. 12, 2011. The disclosures of the application No. 201110230949.7 are incorporated here by reference.

### TECHNICAL FIELD

The present disclosure relates to network technologies, and more particularly, to a method and device for displaying data.

### BACKGROUND

To facilitate understanding, explanations about the following terms involved in the present disclosure are firstly provided.

A Social Network Service (SNS) platform is configured to help a user to expand his or her personal connections, according to six degrees of separation theory. Specifically speaking, a user's personal connections may be expanded unlimited, based on a known friend of a friend, so as to be helped by a contact when necessary.

An Application Program (APP) refers to an application program, which is in the SNS platform and is provided by a third party.

At present, the SNS platform may generally display a total number of users with a certain APP installed, which cannot distinguish each user applying the certain APP. Subsequently, when a user selects whether to install an APP, the SNS platform may not provide any reference information for the user. For example, how many buddies of the user have used the APP, as well as which type of buddies of the user have used the APP, and so on.

### SUMMARY

The present disclosure provides a method and device for displaying data, so as to automatically distinguish each user using an APP.

The technical solutions provided by the present disclosure are as follows.

A method for displaying data, including:
pulling buddy data of user A and user data of a user, who uses an APP selected by user A;
selecting user data of a user, who uses the APP and is a buddy of user A, based on the buddy data pulled and the user data pulled; and
displaying the user data selected.

A device for displaying data, including a pulling unit, a selecting unit and a displaying unit, wherein
the pulling unit is configured to pull buddy data of user A, and user data of a user, who uses an APP selected by user A;
the selecting unit is configured to select user data of a user, who uses the APP and is a buddy of user A, based on the buddy data pulled and the user data pulled; and
the displaying unit is configured to display the user data selected by the selecting unit.

A device for displaying data, including a memory, and a processor in communication with the memory, wherein the memory stores a pulling instruction, a selecting instruction and a displaying instruction, which are executable by the processor,
the pulling instruction indicates to pull buddy data of user A, and user data of a user, who uses an APP selected by user A;
the selecting instruction indicates to select user data of a user, who uses the APP and is a buddy of user A, based on the buddy data pulled and the user data pulled; and
the displaying instruction indicates to display the user data selected based on the selecting instruction.

Based on the foregoing technical solutions, it can be seen that in the present disclosure, selected user data may be displayed, by pulling buddy data of user A and user data of a user, who uses the APP selected by user A, and by selecting user data of a user, who uses the APP and is a buddy of user A, based on the buddy data and user data. Compared with the prior art, by employing the technical solution of the present disclosure, each user using an APP may be automatically distinguished, so as to ensure user A to learn how many buddies are using a certain APP. Subsequently, the learned result may be employed to enable user A to select, install and use an APP.

### BRIEF DESCRIPTIONS OF THE DRAWINGS

FIG. 1 is a basic flowchart in accordance with an example of the present disclosure.

FIG. 2 is a flowchart illustrating block 101, in accordance with an example of the present disclosure.

FIG. 3 is a schematic diagram illustrating structure of a device, in accordance with an example of the present disclosure.

FIG. 4 is a schematic diagram illustrating another structure of a device, in accordance with an example of the present disclosure.

### DETAILED DESCRIPTIONS

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used throughout the present disclosure, the term “includes” means includes but not limited to, the term “including” means including but not limited to. The term “based on” means based at least in part on. In addition, the terms “a” and “an” are intended to denote at least one of a particular element.

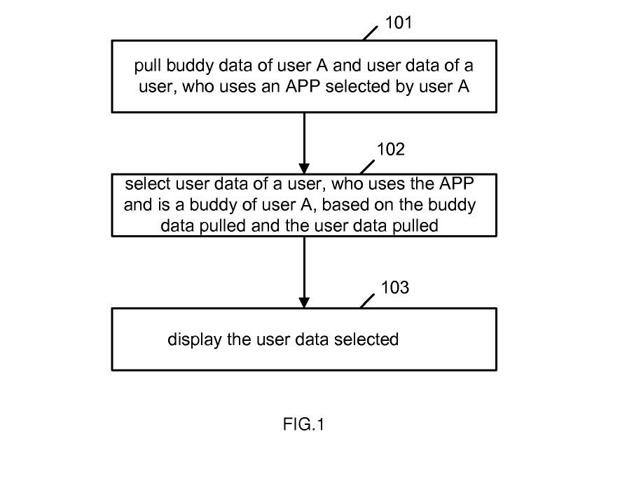

The technical solutions provided by the present disclosure may include the flowchart illustrated with FIG. 1.

With reference to FIG. 1, FIG. 1 is a basic flowchart provided by an example of the present disclosure. As shown in FIG. 1, the method may include the following blocks.

In block 101, pull buddy data of user A and user data of a user, who uses an APP selected by user A.

In block 101, user A may be any user of the SNS platform. To facilitate descriptions, user A is another name of a user.

In addition, the APP in block 101 may be selected by user A, while installation and usage of the APP have not been determined. The number of foregoing APP may be one or more.

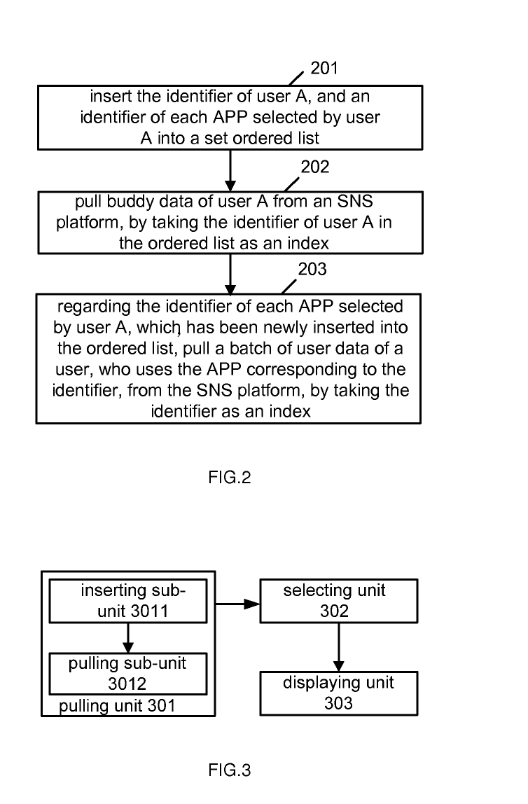

When there are multiple APPs selected by user A, specifically speaking, block 101 may include the methods shown in FIG. 2.

With reference to FIG. 2, FIG. 2 is a flowchart illustrating how to implement block 101, in accordance with an example of the present disclosure. As shown in FIG. 2, the method may include the following blocks.

In block 201, insert the identifier of user A, and an identifier of each APP selected by user A into a set ordered list.

That is, after executing block 201, the ordered list has recorded a corresponding relationship between the identifier of user A and an identifier of an APP selected by user A.

In block 202, pull the buddy data of user A from the SNS platform, by taking the identifier of user A in the ordered list as an index.

In the present disclosure, the SNS platform may record a buddy list of each user. Thus, in block 202, it is easy to pull the buddy data of user A from the buddy list of user A, which is recorded by the SNS platform. The pulled buddy data of user A may be some related information about each buddy of user A, such as the identifier of each buddy of user A, and so on, which is not limited by the present disclosure.

In block 203, regarding the identifier of each APP selected by user A, which has been newly inserted into the ordered list, pull a batch of user data of a user, who uses the APP corresponding to the identifier, from the SNS platform, by taking the identifier as an index.

Since in the SNS platform, a user may install an APP by using a page of the SNS platform. The SNS platform may record an APP installed by each user, and number of users who have installed and used each APP. Subsequently, in block 203, it is easy to pull a batch of user data of a user, who uses the APP, from the SNS platform, by taking the identifier of the APP as an index. Here, the pulled user data may be user related information, such as the identifier of the user, and so on, which is not limited by the present disclosure.

It should be noted that, there is no fixed chronological order for executions of foregoing blocks 202 and 203. Blocks 202 and 203 may be executed simultaneously. Alternatively, block 203 may be firstly executed, and then block 202 may be executed. Still alternatively, block 202 may be executed firstly, and then block 203 may be executed, and so on.

Until now, the method illustrated with FIG. 2 may be completed. By using the method shown in FIG. 2, a batch of buddy data of user A and a batch of user data of a user, who uses the APP selected by user A, may be pulled.

It should be noted that, the method shown in FIG. 2 is provided on the precondition that there may be multiple APPs selected by user A. However, when there is only one APP selected by user A, the method illustrated with FIG. 2 may be also applicable. The difference is that, when there are multiple APPs selected by user A, the condition may be simpler.

It should be noted that, the ordered list in foregoing block 201 may be updated. For example, based on subsequent service requirements, user A may put an identifier of an APP newly selected into the above ordered list. Alternatively, based on service requirements, user A may remove an identifier of a selected APP from the above ordered list, and so on.

In block 102, based on the buddy data pulled and user data pulled, select user data of a user, who uses the APP selected by user A and is a buddy of user A.

Specifically speaking, block 102 may be as follows. Select the same data from the buddy data pulled and user data pulled. Take the selected data as the user data of the user, who uses the APP selected by user A and is a buddy of user A.

In block 103, display the selected user data.

In the example of the present disclosure, the following blocks may be further included before executing block 103. Store the selected user data and the index identifier, which is used when pulling the user data, into a set First In First Out (FIFO) association and simulation container correspondingly. The index identifier includes the identifier of user A and the identifier of the APP, which are used when pulling the user data. That is, after executing the foregoing further included blocks, the association and simulation container has stored a corresponding relationship between the selected user data and the corresponding index identifier of the user data.

Thus, block 103 may be as follows. Determine whether user data amount newly stored into the association and simulation container has achieved a set displaying amount. When determining that the user data amount newly stored into the association and simulation container has achieved the set displaying amount, based on an FIFO principle, select the set amount of user data and the index identifier corresponding to the selected user data from the user data, which has been newly stored into the association and simulation container. Display the selected user data and index identifier.

As an extension of the example of the present disclosure, when determining that the user data amount newly stored into the association and simulation container has not achieved the set displaying amount, it may also display all of the user data selected in block 102 and corresponding index identifier of the user data.

Until now, the method shown in FIG. 1 may be completed.

Based on blocks 101 to 103 shown in FIG. 1, it can be seen that the present disclosure may distinguish each user using the APP, instead of displaying a total number of users using the APP in general.

In the example of the present disclosure, when user A triggers a buddy, e.g., clicks on a buddy, call information about all of the APPs installed by the buddy for user A, and display the called information for user A. Thus, which APP installed by a buddy of user A may be displayed for user A.

Furthermore, based on blocks 102 and 103, it can be seen that in accordance with the example of the present disclosure, the user data needing to be displayed may be obtained by two dimensions, that is, the identifier of user A and an identifier of an APP selected by user A.

In addition, in the example of the present disclosure, the user data selected in block 102 and the index identifier used when selecting the user data may be encapsulated into an interface, to facilitate subsequent usage of other APPs.

Until now, the descriptions about methods provided by examples of the present disclosure are finished. Descriptions about a device in accordance with an example of the present disclosure will be provided in the following.

With reference to FIG. 3, FIG. 3 is a schematic diagram illustrating structure of a device, in accordance with an example of the present disclosure. As shown in FIG. 3, the device may include a pulling unit 301, a selecting unit 302 and a displaying unit 303.

The pulling unit 301 is configured to pull buddy data of user A, and user data of a user, who uses an APP selected by user A.

The selecting unit 302 is configured to select user data of a user, who uses the APP and is a buddy of user A, based on the pulled buddy data and the pulled user data.

The displaying unit 303 is configured to display the user data selected by the selecting unit.

As shown in FIG. 3, the pulling unit 301 further includes an inserting sub-unit 3011 and a pulling sub-unit 3012.

The inserting sub-unit 3011 is configured to insert the identifier of user A, and the identifier of the APP selected by user A into the set ordered list.

The pulling sub-unit 3012 is configured to pull the buddy data of user A from the SNS platform, by taking the identifier of user A in the ordered list as an index.

Regarding the identifier of each APP selected by user A, which has been newly inserted into the ordered list, the pulling sub-unit 3012 is further configured to pull user data of a user, who uses the APP corresponding to the identifier, from the SNS platform, by taking the identifier as an index.

In the example of the present disclosure, the selecting unit 302 may employ the following modes to select user data of a user, who uses the APP and is a buddy of user A. The selecting unit 302 may select the same data from the pulled buddy data and the pulled user data, and take the selected data as the user data of the user, who uses the APP and is a buddy of user A.

The device may further include an association and simulation container, which is not shown in FIG. 3.

The association and simulation container is configured to store the user data selected by the selecting unit, as well as the index identifier used when pulling the user data into the set FIFO association and simulation container. The index identifier includes the identifier of user A and the identifier of the APP, which are used when pulling the user data.

In the example of the present disclosure, based on the association and simulation container, the displaying unit 303 may display the data with the following mode. The displaying unit 303 may determine whether user data amount newly stored into the association and simulation container achieves a set displaying amount. When determining that the user data amount newly stored into the association and simulation container achieves the set displaying amount, the displaying unit 303 may select a set amount of user data from the user data newly stored into the association and simulation container, as well as the index identifier corresponding to the selected user data, based on the FIFO principle. The displaying unit 303 may further display the selected user data and index identifier.

In the example of the present disclosure, the device may further include an interface encapsulating unit, which is not shown in FIG. 3.

The interface encapsulation unit is configured to encapsulate the user data selected by the selecting unit 302, and the index identifier corresponding to the user data into an interface, to facilitate usage of other APPs.

An example of the present disclosure also provides a machine readable storage medium, which may store instructions enabling a machine to execute the method for displaying data as mentioned above. Specifically speaking, a system or device with such storage medium may be provided. The storage medium may store software program codes, which may implement functions of any foregoing example. A computer (or Central Processing Unit (CPU), or Micro Processing Unit (MPU)) of the system or device may read and execute the program codes stored in the storage medium.

In this case, the program codes read from the storage medium may implement functions of any foregoing example. Thus, the program codes and storage medium may form a part of the present disclosure.

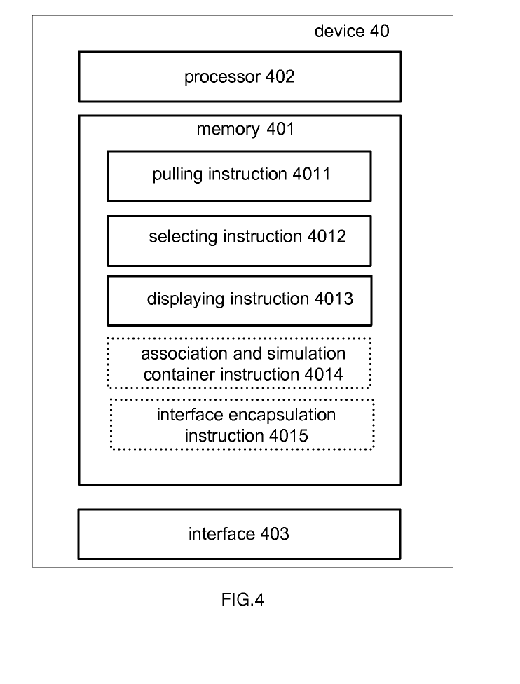

For example, FIG. 4 is a schematic diagram illustrating another structure of a device, in accordance with an example of the present disclosure.

The device 40 may include a memory 401, one or more processors 402 in communication with memory 401, and an interface 403. To simplify descriptions, suppose there is one processor 402 in communication with memory 401, as shown in FIG. 4. Memory 401 is configured to store a pulling instruction 4011, a selecting instruction 4012 and a displaying instruction 4013, which are executable by processor 402.

The pulling instruction 4011 indicates to pull via interface 403 buddy data of user A, and user data of a user, who uses an APP selected by user A.

The selecting instruction 4012 indicates to select user data of a user, who uses the APP and is a buddy of user A, based on the pulled buddy data and the pulled user data.

The displaying instruction 4013 indicates to display the user data selected based on the selecting instruction 4012.

The pulling instruction 4011 further includes an inserting instruction, and a first pulling instruction, which are not shown in FIG. 4.

The inserting instruction indicates to insert the identifier of user A, and the identifier of the APP selected by user A into a set ordered list.

The first pulling instruction indicates to pull the buddy data of user A from the SNS platform, by taking the identifier of user A in the ordered list as an index.

Regarding the identifier of each APP selected by user A, which has been newly inserted into the ordered list, the first pulling instruction further indicates to pull user data of a user, who uses the APP corresponding to the identifier, from the SNS platform, by taking the identifier as an index.

In the example of the present disclosure, the selecting instruction 4012 may indicate to select the user data of the user, who uses the APP and is a buddy of user A, by using the following methods. The selecting instruction 4012 may indicate to select the same data from the pulled buddy data and the pulled user data, and take the selected data as the user data of the user, who uses the APP and is a buddy of user A.

As shown in FIG. 4, memory 401 may further store an association and simulation container instruction 4014 executable by processor 402, which indicates to store the user data selected based on the selecting instruction 4012, and an index identifier used when pulling the user data into a set FIFO association and simulation container. The index identifier includes the identifier of user A and the identifier of the APP, which are used when pulling the user data.

Based on the association and simulation container instruction 4014, in the example of the present disclosure, the displaying instruction 4013 may indicate to display the data by using the following methods. The displaying instruction 4013 may firstly indicate to determine whether user data amount newly stored into the association and simulation container achieves a set displaying amount. When determining that the user data amount newly stored into the association and simulation container achieves the set displaying amount, the displaying instruction 4013 may indicate to select a set amount of user data from the user data newly stored into the association and simulation container, and select the index identifier corresponding to the selected user data, based on the FIFO principle. The displaying instruction 4013 further indicates to display the selected user data and index identifier.

Memory 401 may further store an interface encapsulation instruction 4015 executable by processor 402. The interface encapsulation instruction 4015 indicates to encapsulate the user data selected based on the selecting instruction 4012, and the index identifier corresponding to the user data into an interface, for other APPs to use.

Until now, descriptions about the devices provided by examples of the present disclosure are finished.

Based on the foregoing technical solutions, it can be seen that in the examples of the present disclosure, by pulling the buddy data of user A and user data of a user, who uses the APP selected by user A, and by selecting user data of a user, who uses the APP and is a buddy of user A, based on the buddy data and the user data, and then display the selected user data. Compared with the prior art, each user using an APP may be automatically distinguished, so as to guarantee that user A may learn how many buddies are using a certain APP. User A may further select whether to install and use the APP, based on the learning result.

The foregoing is only examples of the present disclosure, which is not used for limiting the present disclosure. Any modifications, equivalent substitutions and improvements made within the spirit and principle of the present disclosure, should be covered by the protection scope of the present disclosure.

1. A method for displaying data, comprising:
pulling buddy data of user A and user data of a user, who uses an Application Program (APP) selected by user A;
selecting user data of a user, who uses the APP and is a buddy of user A, based on the buddy data pulled and the user data pulled; and
displaying the user data selected.

2. The method according to claim 1, wherein pulling the buddy data of user A and the user data of the user, who uses the APP selected by user A, comprise:
inserting the identifier of user A, and the identifier of the APP selected by user A into a set ordered list;
pulling the buddy data of user A from a Social Network Service (SNS) platform, by taking the identifier of user A in the ordered list as an index;
regarding an identifier of each APP selected by user A, which has been newly inserted into the ordered list, pulling the user data of the user, who uses the APP corresponding to the identifier, from the SNS platform, by taking the identifier as an index.

3. The method according to claim 1, wherein selecting the user data of the user, who uses the APP and is the buddy of user A, based on the buddy data pulled and the user data pulled, comprise:
selecting the same data from the buddy data pulled and the user data pulled, and
taking the data selected as the user data of the user, who uses the APP and is the buddy of user A.

4. The method according to claim 2, further comprising:
storing the user data selected, and the index identifier used when pulling the user data correspondingly into a set First In First Out (FIFO) association and simulation container, wherein the index identifier comprises the identifier of user A and the identifier of the APP, which are used when pulling the user data;
wherein displaying the user data selected comprises:
determining whether user data amount newly stored into the association and simulation container achieves a set displaying amount;
when determining that the user data amount newly stored into the association and simulation container achieves the set displaying amount, selecting a set amount of user data from the user data newly stored into the association and simulation container, based on an FIFO principle, selecting the index identifier corresponding to the user data selected, displaying the user data selected and the index identifier selected.

5. The method according to claim 4, further comprising:
encapsulating the user data selected, and the index identifier corresponding to the user data into an interface, for other APPs to use.

6. A device for displaying data, comprising a pulling unit, a selecting unit and a displaying unit, wherein
the pulling unit is configured to pull buddy data of user A, and user data of a user, who uses an Application Program (APP) selected by user A;
the selecting unit is configured to select user data of a user, who uses the APP and is a buddy of user A, based on the buddy data pulled and the user data pulled; and
the displaying unit is configured to display the user data selected by the selecting unit.

7. The device according to claim 6, wherein the pulling unit comprises an inserting sub-unit and a pulling sub-unit,
the inserting sub-unit is configured to insert the identifier of user A, and the identifier of the APP selected by user A into a set ordered list;
the pulling sub-unit is configured to pull the buddy data of user A from a Social Network Service (SNS) platform, by taking the identifier of user A in the ordered list as an index, and
regarding an identifier of each APP selected by user A, which has been newly inserted into the ordered list, the pulling sub-unit is further configured to pull the user data of the user, who uses the APP corresponding to the identifier, from the SNS platform, by taking the identifier as an index.

8. The device according to claim 6, wherein the selecting unit is further configured to select the same data from the buddy data pulled and the user data pulled, and take the data selected as the user data of the user, who uses the APP and is the buddy of user A.

9. The device according to claim 8, wherein the device further comprises an association and simulation container, which is configured to store the user data selected by the selecting unit, and the index identifier used when pulling the user data correspondingly into a set First In First Out (FIFO) association and simulation container, and the index identifier comprises the identifier of user A and the identifier of the APP, which are used when pulling the user data; and
the displaying unit is further configured to determine whether user data amount newly stored into the association and simulation container achieves a set displaying amount;
when determining the user data amount newly stored into the association and simulation container achieves the set displaying amount, the displaying unit is further configured to select a set amount of user data from the user data newly stored into the association and simulation container, based on an FIFO principle, and select the index identifier corresponding to the selected user data, and display the selected user data and index identifier.

10. The device according to claim 6, wherein the device further comprises an interface encapsulating unit, which is configured to encapsulate the user data selected by the selecting unit, and the index identifier corresponding to the user data into an interface, for other APPs to use.

11. A device for displaying data, comprising a memory, and a processor in communication with the memory, wherein the memory stores a pulling instruction, a selecting instruction and a displaying instruction, which are executable by the processor,
the pulling instruction indicates to pull buddy data of user A, and user data of a user, who uses an Application Program (APP) selected by user A;
the selecting instruction indicates to select user data of a user, who uses the APP and is a buddy of user A, based on the buddy data pulled and the user data pulled; and
the displaying instruction indicates to display the user data selected based on the selecting instruction.

12. The device according to claim 11, wherein the pulling instruction comprises an inserting instruction and a first pulling instruction,
the inserting instruction indicates to insert the identifier of user A, and the identifier of the APP selected by user A into a set ordered list;
the first pulling instruction indicates to pull the buddy data of user A from a Social Network Service (SNS) platform, by taking the identifier of user A in the ordered list as an index, and
regarding an identifier of each APP selected by user A, which has been newly inserted into the ordered list, the first pulling instruction further indicates to pull the user data of the user, who uses the APP corresponding to the identifier, from the SNS platform, by taking the identifier as an index.

13. The device according to claim 11 wherein the selecting instruction further indicates to select the same data from the buddy data pulled and the user data pulled, and take the data selected as the user data of the user, who uses the APP and is the buddy of user A.

14. The device according to claim 13, wherein the device further comprises an association and simulation container, which is configured to store the user data selected based on the selecting instruction, and the index identifier used when pulling the user data correspondingly into a set First In First Out (FIFO) association and simulation container, and the index identifier comprises the identifier of user A and the identifier of the APP, which are used when pulling the user data; and
the displaying instruction further indicates to determine whether user data amount newly stored into the association and simulation container achieves a set displaying amount;
when determining the user data amount newly stored into the association and simulation container achieves the set displaying amount, the displaying instruction further indicates to select a set amount of user data from the user data newly stored into the association and simulation container, based on an FIFO principle, and select the index identifier corresponding to the selected user data, and display the selected user data and index identifier.

15. The device according to claim 11, wherein the memory further stores an interface encapsulating instruction executable by the processor, which indicates to encapsulate the user data selected based on the selecting instruction, and the index identifier corresponding to the user data into an interface, for other APPs to use.
